(19) United States
(12) Patent Application Publication
(10) Pub. No.: US 2011/0270664 A1
(43) Pub. Date: Nov. 3, 2011

(54) LOYALTY REDEMPTION

(75) Inventor: Dewayne Jones, Birmingham, AL (US)

(73) Assignee: Regions Asset Company, Wilmington, DE (US)

(21) Appl. No.: 13/098,024

(22) Filed: Apr. 29, 2011

Related U.S. Application Data
(60) Provisional application No. 61/329,968, filed on Apr. 30, 2010.

(51) Int. Cl. G06Q 30/00

(52) U.S. Cl. 705/14.33

(57) ABSTRACT

A loyalty redemption system and related methods are disclosed. The loyalty redemption system can include a card.

### CLAIM OF PRIORITY

This application claims priority to U.S. Provisional Patent Application No. 61/329,968, filed on Apr. 30, 2010, which is incorporated by reference in its entirety.

### TECHNICAL FIELD

This invention relates to a loyalty redemption system and related methods.

### BACKGROUND

Loyalty programs can be structured marketing efforts that reward and encourage loyal buying behavior, which can be potentially of benefit to the merchant.

### SUMMARY

In one aspect, a method of permitting prepaid purchase instrument creation can include logging into a user account to redeem an amount of loyalty points for a purchase instrument of a merchant and activating the purchase instrument and updating the amount of loyalty points left in the user account. The merchant can be selected by the customer among a plurality of contract merchants and the amount of redeemed loyalty points can be determined by the customer. The method can further include customizing the purchase instrument at a cost of a predetermined amount of loyalty points. The method can further include creating the purchase instrument based on the merchant and loyalty points selection. The method can further include communicating the loyalty points redemption to the selected merchant.

The purchase instrument can be a gift card. The method can further include customizing the gift card by uploading a customized image and adding custom text. The method can further include selecting a gift card layout among a plurality of card layout templates. The purchase instrument can be a printable coupon. The purchase instrument can be a gift certificate. The purchase instrument can be a code. The method can further include sending the code to the customer in an email. The method can further include transferring an amount of loyalty points from the user account to an amount of value on the purchase instrument. The method can further include transferring an amount of value on the purchase instrument back to an amount of loyalty points of the user account. The method can further include earning loyalty points for a purchase transaction. The method can further include storing the loyalty points in the user account.

In another aspect, a prepaid purchase instrument redemption system can include a transaction database configured to enable a customer to earn loyalty points for a purchase transaction, a user account storing the amount of loyalty points, a network interface allowing the customer to log into the user account to redeem an amount of loyalty points for a purchase instrument of a merchant, and a graphical interface allowing the customer to customize the purchase instrument. The merchant can be selected by the customer among a plurality of contract merchants and the amount of redeemed loyalty points can be determined by the customer. The system can include a processing module creating the purchase instrument based on the merchant and loyalty points selection, activating the purchase instrument and updating the amount of loyalty points left in the user account.

The system can be configured to charge the customer a predetermined amount of loyalty points for customizing the purchase instrument. The purchase instrument can be a gift card. The system can be configured to customize the gift card by uploading a customized image. The system can be configured to customize the gift card by adding custom text. The graphical interface can be configured to display a plurality of card layout templates, the customer selecting a gift card layout among the plurality of card layout templates. The system can be configured to transfer an amount of loyalty points from the user account to an amount of value on the purchase instrument. The system can be configured to transfer an amount of value on the purchase instrument back to an amount of loyalty points of the user account. The network interface can be configured to be accessed from a mobile device. The network interface can include at least one link to the websites of the plurality of contract merchants. The system can be configured to communicate the loyalty points redemption to the selected merchant.

### DESCRIPTION OF DRAWINGS

FIG. 1 is a flow chart illustrating a loyalty redemption process.

FIG. 2 is a diagram illustrating a loyalty redemption system.

FIG. 3 is a flow chart illustrating a loyalty redemption process.

FIG. 4 is a diagram illustrating a screen display to navigate a loyalty redemption process.

FIG. 5 is a diagram illustrating a screen display to navigate a loyalty redemption process.

FIG. 6 is a diagram illustrating a screen display to navigate a loyalty redemption process.

FIG. 7 is a diagram illustrating a screen display to navigate a loyalty redemption process.

### DETAILED DESCRIPTION

In marketing and retailing, a loyalty card, rewards card, points card, advantage card, or club card is a plastic or paper card that identifies the card holder as a member in a loyalty program. Loyalty cards are a system of the loyalty business model. Cards typically can have a barcode or magnetic strip that can be easily scanned, and some cards include programmable chips. Managing gift card inventory and liability is important for loyalty providers as they must be purchased in advance from merchants and banks. A loyalty redemption system and related methods can improve purchase instrument (e.g. gift card) inventory management issues and reduce or eliminate risk from instrument purchased in advance.

The system can be configured to charge the customer a predetermined amount of loyalty points for customizing the purchase instrument. The purchase instrument can be any suitable instrument, such as gift card, coupon, gift certificate, or a code. For example, the system can be configured to customize the gift card by uploading a customized image. The system can be configured to customize the purchase instrument by adding custom text. The graphical interface can be configured to display a plurality of card layout templates. The customer can select a purchase instrument layout among the plurality of card layout templates. The system can be configured to transfer an amount of loyalty points from the user account to an amount of value on the purchase instrument. The system can be configured to transfer an amount of value on the purchase instrument back to an amount of loyalty points of the user account. The network interface can be configured to be accessed from a mobile device. The network interface can include at least one link to the websites of the plurality of contract merchants. The system can be configured to communicate the loyalty points redemption to the selected merchant.

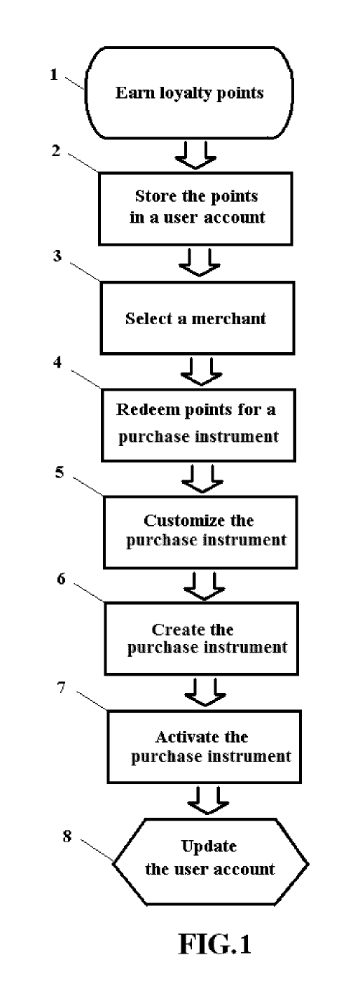

FIG. 1 illustrates the process of loyalty point redemption and purchase instrument customization. At first, a customer can earn loyalty points for a purchase transaction. In step 2, the points can be stored in a user account. In step 3, the customer can log into the user account to select a purchase instrument of a merchant among a plurality of contract merchants. In step 4, the customer can redeem an amount of loyalty points for the purchase instrument of a merchant, wherein the mount of redeemed loyalty points is determined by the customer. In step 5, the customer can customize the purchase instrument. In some embodiments, the customer can customize the purchase instrument at a cost of a predetermined amount of loyalty points. Further, in step 6, the customer can choose to create the purchase instrument based on the merchant and loyalty points selection. In some embodiments, the customer can order the purchase instrument online and the purchase instrument can be mailed to the address provided by the customer. In step 7, the purchase instrument can be activated. The activation can be done online or at a merchant computer. In step 8, the user account can be updated with the amount of loyalty points left in the user account. The process can include a further step of communicating the loyalty points redemption to the selected merchant. Additionally, all purchase instrument related activities, such as activations, creations, transactions or point transferring, can be reported to the merchants on an ongoing basis.

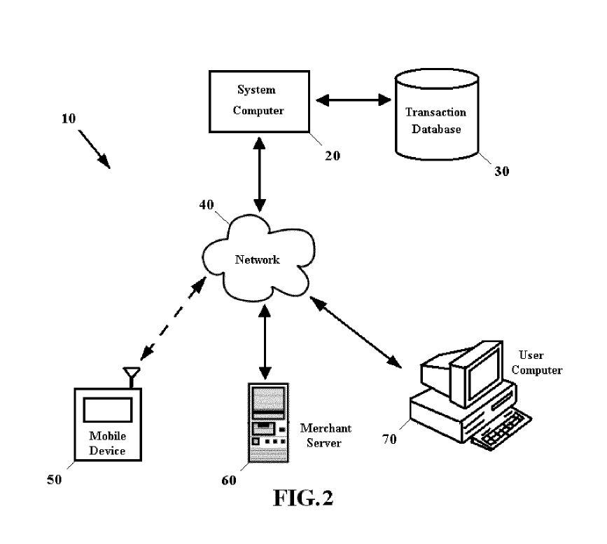

FIG. 2 illustrates prepaid purchase instrument redemption system 10. System 10 can include system computer 20, transaction database 30, and network 40. Customers can access their user accounts from mobile device 50, merchant server 60, or user computer 70. Mobile device 50, merchant server 60, or user computer 70 can be operatively coupled to system computer 20 via a network 40. System computer 20 can be accessed from different geographic locations, e.g. different areas of the same city, or in different states. Network 40 can be provided using any suitable techniques for the transfer of electronic data. For example, network 40 can include dedicated access lines, plain ordinary telephone lines, satellite links, wireless network, or any combinations of the above-mentioned networks. In some embodiments, network 40 can further include a plurality of routers, network computers or server computers (not shown in FIG. 2), each of which may be operatively interconnected in a known manner. In some embodiments, network 40 can include the Internet. Data communication can take place over network 40 via an Internet communication protocol. System computer 20 can be a server computer of any suitable type employed in networking solutions. For example, system computer 20 can direct and monitor the request from customer's mobile device 50 to transaction database 30. System computer 20 can be used to accumulate, analyze, and download store data. For example, System computer 20 may periodically receive data from merchant server 60 containing information of customers' accumulated loyalty points. Transaction database 30 can include a user account information database. Transaction database 30 can further store the information of any customer's transaction involving loyalty point earning.

Although purchase instrument redemption system 10 is shown to include one set of system computer 20 and transaction database 30, it should be understood that different numbers of computers, servers, and databases may be utilized. For example, in some embodiments, purchase instrument redemption system 10 can include a plurality of system computers 20 and transaction databases 30, all of which may be interconnected via network 40. Each set of system computers 20 and transaction databases 30 can be designated to focusing a certain kind of transaction, a certain group of customers, or a specific geographical area.

According to the embodiment disclosed by FIG. 2, purchase instrument redemption system 10 can have several advantages, such as, for example, enabling near real time uploads and downloads of information as well as periodic uploads and downloads of information. This provides for a primary backup of all the information generated in the process of updating and accumulating loyalty point data.

In some embodiments, mobile device 50, merchant server 60, or user computer 70 can include a network interface allowing the customer to log into the user account to redeem an amount of loyalty points for a purchase instrument of a merchant. The merchant is selected by the customer among a plurality of contract merchants and the amount of redeemed loyalty points is determined by the customer. Mobile device 50, merchant server 60, or user computer 70 can provide a graphical interface allowing the customer to customize the purchase instrument (e.g. gift card).

In some embodiments, purchase instrument redemption system 10 can further include a processing module printing the gift card based on the merchant and loyalty points selection and activating the gift card. In some embodiments, the process module can send the purchase instrument in an electronic form (e.g. gift card, printable coupon, or certificate) to the customer in an email. In some embodiments, the process module can store the purchase instrument in an electronic form and send the customer a link to access it. The link can be password protected.

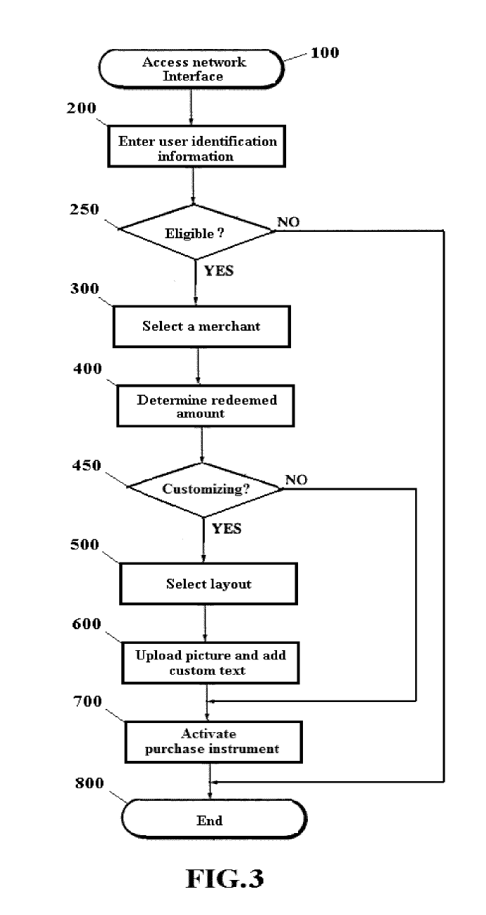

FIG. 3 illustrates a flow diagram of a purchase instrument redemption process. The first step can be accessing the network interface 100. The user identification information can be entered in step 200. Next, the purchase instrument redemption process can determine 250 if the user is eligible to proceed to the following steps. If yes, the customer can select a merchant loyalty purchase instrument 300, otherwise the process will be ended automatically 800. The customer can determine the mount of redeemed loyalty points 400.

In step 450, the customer can determine if he/she wants to customize the purchase instrument. In some embodiments, the customer can customize the purchase instrument at a cost of a predetermined amount of loyalty points. Then, the customer can select a layout from a group of layout templates 500. The customer can further choose to upload a picture or add text to the customized purchase instrument 600. At the end of the process, the purchase instrument will be activated 700. If the customer chooses not to customize the purchase instrument, the purchase instrument can still be activated 700 without any customization.

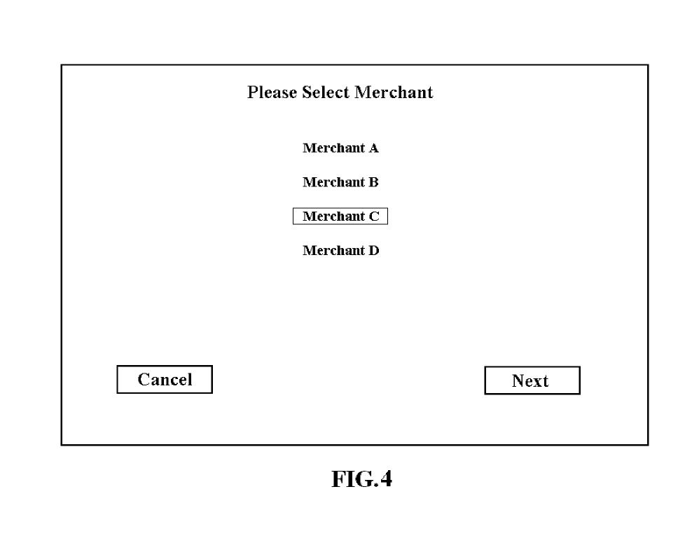

FIGS. 4 to 7 illustrate a plurality of graphical display that can be used to guide a customer through a purchase instrument redemption process. In FIG. 4, after logging in his/her user account, the customer can be provided a list of participating (or contracted) merchant in which the purchase instrument may be redeemed. The graphical display can include at least one link to the websites of the plurality of contract merchants. In some embodiments, the purchase instrument can be redeemed at more than one merchant. For example, some merchants, such as retail companies or amusement parks, may want to cross sale purchase instrument with other merchants.

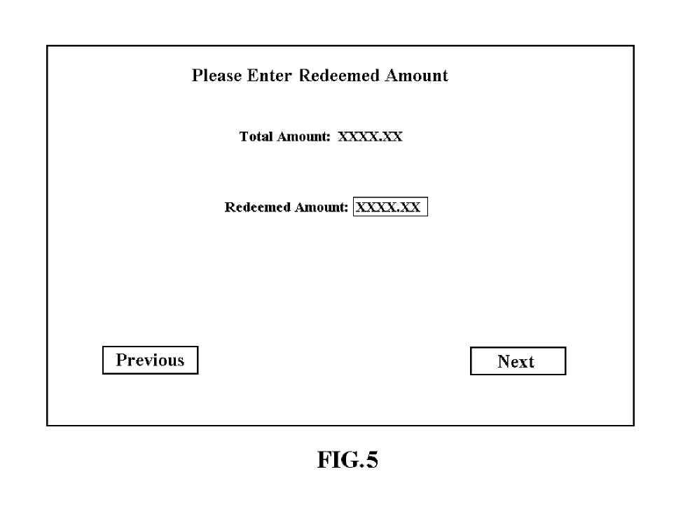

In FIG. 5, the customer can entered the amount of loyalty points to be redeemed and put on the purchase instrument. The total amount of accumulated loyalty points can be provided to the customer in the same graphical display.

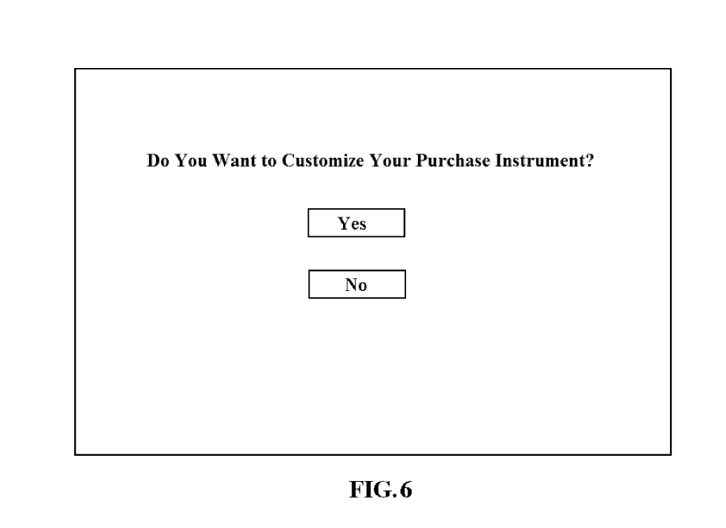

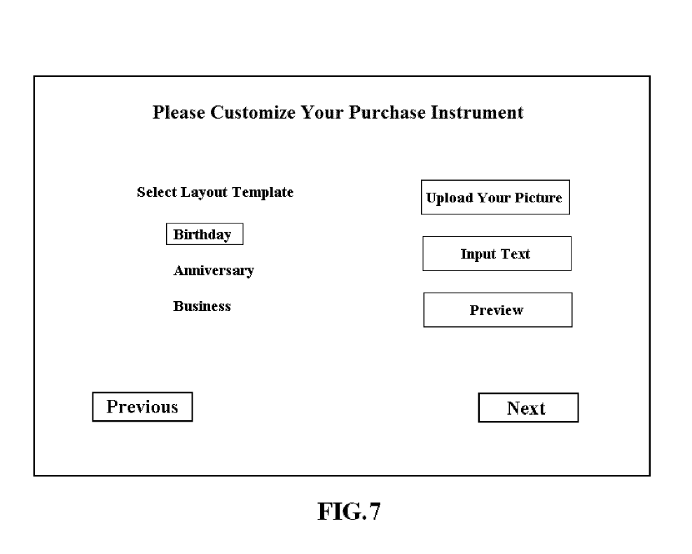

In FIG. 6, the customer can decide to customize the purchase instrument or not. In FIG. 7, a graphical display of purchase instrument customization can include a list of layout template categories. Categories may be generally organized by event or recipient. As shown in FIG. 7, for example, a list of general categories may include birthday, anniversary, or business layout. In some embodiments, these categories can be further broken into subcategories. In FIG. 7, the graphical display of purchase instrument customization can include options for uploading picture and inputting text. After all customization are done, a preview option can be included to give the customer a preview of generated purchase instrument. In some embodiments, the selection of layout templates can further include at one graphical display of the available designs.

In some embodiments, the purchase instrument redemption system can further include a process and related interfaces for transferring an amount of value on the purchase instrument back to the user account.

A number of embodiments of the invention have been described. Nevertheless, it will be understood that various modifications may be made without departing from the spirit and scope of the invention. It should also be understood that the appended drawings are not necessarily to scale, presenting a somewhat simplified representation of various preferred features illustrative of the basic principles of the invention.

What is claimed is:

1. A method of permitting prepaid purchase instrument creation comprising:
logging into a user account to redeem an amount of loyalty points for a purchase instrument of a merchant, wherein the merchant is selected by the customer among a plurality of contract merchants and the amount of redeemed loyalty points is determined by the customer; and
activating the purchase instrument and updating the amount of loyalty points left in the user account.

2. The method of claim 1 further comprising customizing the purchase instrument at a cost of a predetermined amount of loyalty points.

3. The method of claim 1 further comprising creating the purchase instrument based on the merchant and loyalty points selection.

4. The method of claim 1 further comprising communicating the loyalty points redemption to the selected merchant.

5. The method of claim 1, wherein the purchase instrument is a gift card.

6. The method of claim 5 further comprising customizing the gift card by uploading a customized image and adding custom text.

7. The method of claim 5 further comprising selecting a gift card layout among a plurality of card layout templates.

8. The method of claim 1, wherein the purchase instrument is a printable coupon.

9. The method of claim 1, wherein the purchase instrument is a gift certificate.

10. The method of claim 1, wherein the purchase instrument is a code.

11. The method of claim 10 further comprising sending the code to the customer in an email.

12. The method of claim 1 further comprising transferring an amount of loyalty points from the user account to an amount of value on the purchase instrument.

13. The method of claim 1 further comprising transferring an amount of value on the purchase instrument back to an amount of loyalty points of the user account.

14. The method of claim 1 further comprising earning loyalty points for a purchase transaction.

15. The method of claim 1 further comprising storing the loyalty points in the user account.

16. A prepaid purchase instrument redemption system comprising:
a transaction database configured to enable a customer to earn loyalty points for a purchase transaction;
a user account storing the amount of loyalty points;
a network interface allowing the customer to log into the user account to redeem an amount of loyalty points for a purchase instrument of a merchant, wherein the merchant is selected by the customer among a plurality of contract merchants and the mount of redeemed loyalty points is determined by the customer;
a graphical interface allowing the customer to customize the purchase instrument; and
a processing module creating the purchase instrument based on the merchant and loyalty points selection, activating the purchase instrument and updating the amount of loyalty points left in the user account.

17. The system of claim 16, wherein the system is configured to charge the customer a predetermined amount of loyalty points for customizing the purchase instrument.

18. The system of claim 16, wherein the purchase instrument is a gift card.

19. The system of claim 18, wherein the system is configured to customize the gift card by uploading a customized image.

20. The system of claim 18, wherein the system is configured to customize the gift card by adding custom text.

21. The system of claim 18, wherein the graphical interface is configured to display a plurality of card layout templates, the customer selecting a gift card layout among the plurality of card layout templates.

22. The system of claim 16, wherein the purchase instrument is a printable coupon.

23. The system of claim 16, wherein the purchase instrument is a gift certificate.

24. The system of claim 16, wherein the purchase instrument is a code sent to the customer in an email.

25. The system of claim 16, wherein the system is configured to transfer an amount of loyalty points from the user account to an amount of value on the purchase instrument.

26. The system of claim 16, wherein the system is configured to transfer an amount of value on the purchase instrument back to an amount of loyalty points of the user account.

27. The system of claim 16, wherein the network interface is configured to be accessed from a mobile device.

28. The system of claim 16, wherein the network interface comprises at least one link to the websites of the plurality of contract merchants.

29. The system of claim 16, wherein the system is configured to communicate the loyalty points redemption to the selected merchant.
